(19) United States
(12) Patent Application Publication
(10) Pub. No.: US 2016/0138371 A1
(43) Pub. Date: May 19, 2016

(54) Systems and Methods For Optimizing Existing Wells and Designing New Wells Based on the Distribution of Average Effective Fracture Lengths

(71) Applicant: LANDMARK GRAPHICS CORPORATION, Houston, TX (US)

(72) Inventors: Jan Loaiza, Katy, TX (US); Marko Maucec, Englewood, CO (US)

(21) Appl. No.: 14/778,749

(22) PCT Filed: Jun. 14, 2013
(86) PCT No.: PCT/US13/45958

§ 371 Date: Sep. 21, 2015

(51) Int. Cl. E21B 41/00; G06F 17/18

(52) U.S. Cl. CPC E21B 41/0092; G06F 17/18

(57) ABSTRACT

Systems and methods for optimizing existing wells and designing new wells based on the distribution of each average effective fracture length for a respective per fracturing stage with respect to different reservoir properties.

### CROSS-REFERENCE TO RELATED APPLICATIONS

Not applicable.

### STATEMENT REGARDING FEDERALLY SPONSORED RESEARCH

Not applicable.

### FIELD OF THE INVENTION

The present invention generally relates to systems and methods for optimizing existing wells and designing new wells based on the distribution of average effective fracture lengths. More particularly, the present invention relates to optimizing existing wells and designing new wells based on the distribution of each average effective fracture length for a respective fracturing stage with respect to different reservoir properties.

### BACKGROUND OF THE INVENTION

The history matching of well production profiles represents an important component in field development planning. In unconventional plays it is essential to history-match, on a reservoir well by well basis, the production decay curves of fluids using a single well simulator and to accurately estimate the improved permeability (kᵢₘₚ) associated with the stimulated reservoir (drainage) volume (SRV) induced by the fracture system. It is important to note that improved permeability is not only associated with the permeability matrix, but also corresponds to the enhanced fluid-flow properties of the fracture system.

Traditionally, when micro-seismic monitoring data is not available, the history matching process assumes a simplistic model of the induced fracture system composed of several stages of bi-wing fractures with the same (x_{eff}), the same (SRV) and only one bi-wing fracture per stage as illustrated by the simple schematic model in FIG. 5A. In FIG. 5A, the bi-wing fractures are elongated fractures that generally extend perpendicular to the well axis. In the fracture plane, each bi-wing fracture extends virtually the same length in both directions. Bi-wing fractures are usually modeled with two main parameters: fracture length, also referred to as effective fracture length, and fracture width. The two parameters usually correlate with the improved permeability of the permeability matrix that is contacted by the fractures. The relation between improved permeability and the effective fracture length is thus, described by equation 1:

\sqrt{kᵢₘₚ*x_{eff}}=constant (1)

Referring now to FIG. 1, a flow diagram of a conventional method 100 for history matching production profiles using a single well reservoir simulator is illustrated.

In step 102, standard reservoir properties (e.g. formation thickness, BHP, matrix porosity and permeability, rock types, standard fracture design properties (e.g. effective fracture length and fracture width of a simple bi-wing fracture), and production data profiles (e.g. gas/oil/water rates and BHP) are input into a single well reservoir simulator.

In step 104, history matching is performed by the single well reservoir simulator using techniques well-known in the art for history matching and the data input from step 102.

In step 106, the improved permeability (kᵢₘₚ) of the SRV as a result of the history matching performed in step 104 is displayed. This conventional method 100 for history matching determines a standard estimation of improved permeability but often renders sub-optimal forecasts of well production performance. The challenge therefore, is to more accurately estimate the effective fracture length that represents a more realistic fracture system than the model comprising several stages of bi-wing fractures with the same (x_{eff}), the same (SRV) and only one bi-wing fracture per stage.

### BRIEF DESCRIPTION OF THE DRAWINGS

The present invention is described below with references to the accompanying drawings in which like elements are referenced with like reference numerals, and in which:

FIG. 1 is a flow diagram illustrating a conventional method for history matching production profiles using a single well reservoir simulator.

FIG. 2 is a flow diagram illustrating one embodiment of a method for implementing the present invention.

FIG. 3 is a flow diagram illustrating one embodiment of a method for performing step 204 in FIG. 2.

FIG. 4A is a display illustrating a collection of micro-seismic imaging events associated with a fracture cluster.

FIG. 4B is a display illustrating 3D fracture planes based on a time correlation of the micro-seismic imaging events in FIG. 4A.

FIG. 5A is a simple schematic model of an induced fracture system illustrating bi-wing fractures with the same (x_{eff}), the same (SRV) and only one fracture per stage.

FIG. 5B is a complex schematic model of an induced fracture system illustrating multiple-complex fracture networks each with different (x_{eff}), different (SRV) and multiple fractures per stage.

FIG. 6 is block diagram illustrating one embodiment of a computer system for implementing the present invention.

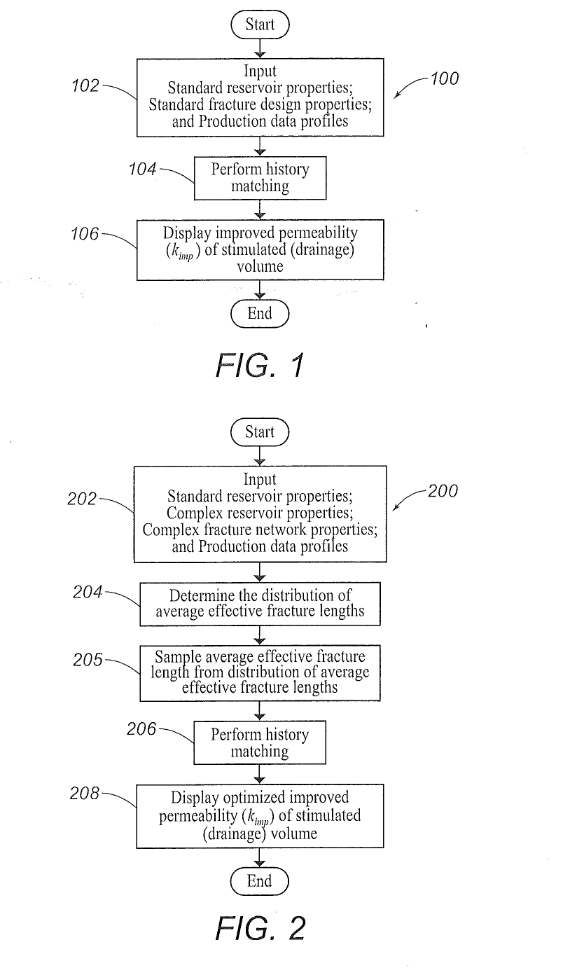

### DETAILED DESCRIPTION OF THE PREFERRED EMBODIMENTS

The present invention therefore, overcomes one or more deficiencies in the prior art by providing systems and methods for optimizing existing wells and designing new wells based on the distribution of each average effective fracture length for a respective fracturing stage with respect to different reservoir properties.

In one embodiment, the present invention includes a method for optimizing well production in a stimulated reservoir volume, which comprises i) inputting one or more complex reservoir properties and one or more complex fracture network properties, the complex fracture network properties comprising data corresponding to clusters in a complex fracture network model; ii) determining a distribution of average effective fracture lengths based on the complex reservoir properties and the complex fracture network properties; iii) sampling an average effective fracture length from the distribution of average effective fracture lengths using a computer processor; and iv) optimizing well production by history matching using the distribution of average effective fracture lengths and the sampled average effective fracture length to improve permeability of the simulated reservoir volume.

In another embodiment, the present invention includes a non-transitory program carrier device tangibly carrying computer executable instructions for optimizing well production in a stimulated reservoir volume, which comprises i) inputting one or more complex reservoir properties and one or more complex fracture network properties, the complex fracture network properties comprising data corresponding to clusters in a complex fracture network model; determining a distribution of average effective fracture lengths based on the complex reservoir properties and the complex fracture network properties; iii) sampling an average effective fracture length from the distribution of average effective fracture lengths; and iv) optimizing well production by history matching using the distribution of average effective fracture lengths and the sampled average effective fracture length to improve permeability of the simulated reservoir volume.

In yet another embodiment, the present invention includes a non-transitory program carrier device tangibly carrying computer executable instructions for optimizing well production in a stimulated reservoir volume, which comprises i) inputting one or more complex reservoir properties and one or more complex fracture network properties, the complex fracture network properties comprising data corresponding to clusters in a complex fracture network model; ii) determining a distribution of average effective fracture lengths by: a) reading an effective fracture length for each fracture plane in each fracturing stage for each well; b) calculating an average effective fracture length for each fracturing stage using each effective fracture length for a respective fracturing stage; and c) building the distribution of average effective fracture lengths by correlating the average effective fracture length for each respective fracturing stage with each reservoir or well-log property; iii) sampling the average effective fracture length from the distribution of average effective fracture lengths; and iv) optimizing well production by history matching using the distribution of average effective fracture lengths and the sampled average effective fracture length to improve permeability of the simulated reservoir volume.

The subject matter of the present invention is described with specificity, however, the description itself is not intended to limit the scope of the invention. The subject matter thus, might also be embodied in other ways, to include different steps or combinations of steps similar to the ones described herein, in conjunction with other technologies. Moreover, although the term “step” may be used herein to describe different elements of methods employed, the term should not be interpreted as implying any particular order among or between various steps herein disclosed unless otherwise expressly limited by the description to a particular order. While the following description refers to the oil and gas industry, the systems and methods of the present invention are not limited thereto and may also be applied in other industries to achieve similar results.

### Method Description

Referring now to FIG. 2, a flow diagram of one embodiment of a method 200 for implementing the present invention is illustrated. The method 200 optimizes history matching production profiles using a single well reservoir simulator.

In step 202, standard reservoir properties (e.g. formation thickness, BHP, matrix porosity and permeability, rock types), complex reservoir properties (e.g. petrophysical properties (e.g. HC content, clay content)) from advanced petrophysical well-log interpretation using mapped properties (e.g. TOC, porosity and brittleness) spatially distributed over the reservoir and constrained with well data), complex fracture network (“CFN”) properties (e.g. data corresponding to clusters in a CFN model), and production data profiles (e.g. gas/oil/water rates and BHP) are input into a single well reservoir simulator using the client interface and/or the video interface described further in reference to FIG. 6. Clusters provide a much more accurate representation of the fracture system because fracking produces not only an elongated bi-wing fracture but rather, a network of smaller complex fractures that are preferably all interconnected and communicate between each other that form a CFN. Each CFN is impacted by other rock properties such as, for example, the standard reservoir properties and the mapped properties mentioned hereinabove.

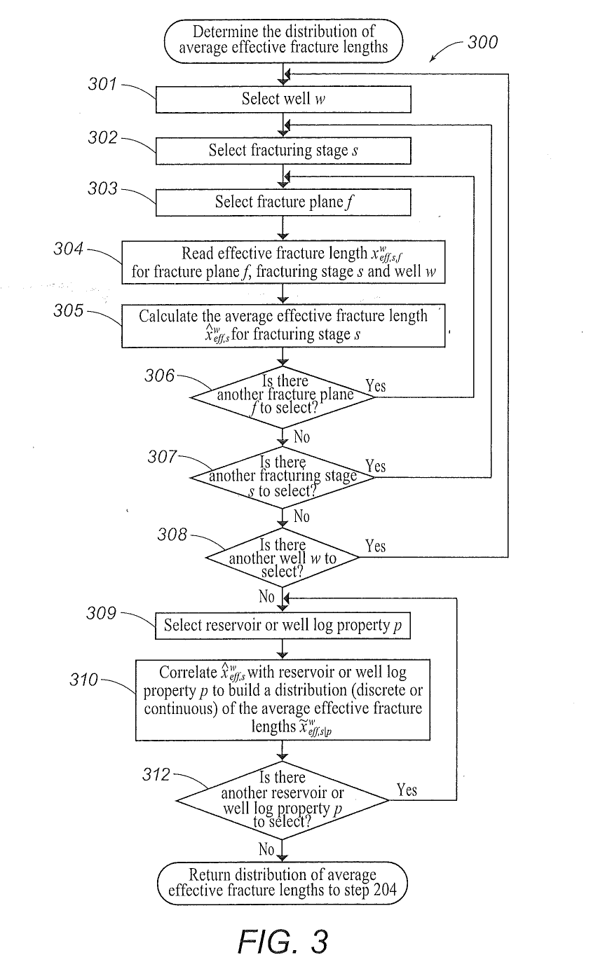

In step 204, the distribution of average effective fracture lengths is determined. One embodiment of a method for performing this step is described further in reference to FIG. 3.

In step 205, the average effective fracture length is sampled from the distribution of average effective fracture lengths (discrete or continuous) determined in step 204. Any well-known standard probabilistic sampling technique (e.g. random sampler) may be used for sampling. In this manner, uncertainty maps of estimated improved permeability (kᵢₘₚ) can be generated with lower median and higher probability scenarios (e.g. P10, P50 and P90 models).

In step 206, history matching is performed by the SRV using the standard reservoir properties and production data profiles input from step 202, the distribution of average effective fracture lengths from step 204, the sampled average effective fracture length from step 205 and techniques well-known in the art for history matching.

In step 208, the optimized improved permeability (kᵢₘₚ) of the as a result of the history matching performed in step 206 is displayed using the video interface described further in reference to FIG. 6. The method 200 will render more accurate forecasts of well production performance, which can be used to optimize existing wells and design new wells, because it is based on and incorporates complex reservoir properties and CFN properties, which optimize the distribution of average effective fracture lengths. In other words, the CFN is no longer correlated with effective fracture length/width and improved permeability but rather, is correlated with the SRV. The objective therefore, is to generate CFNs that maximize the SRV and develop models that more accurately represent the actual SRV.

Referring now to FIG. 3, a flow diagram of one embodiment of a method 300 for performing step 204 in FIG. 2 is illustrated.

In step 301, a well (w) is automatically selected from a total number of wells (W) input in step 202 or, alternatively, may be selected using the client interface and/or the video interface described further in reference to FIG. 6.

In step 302, a fracturing stage (s) is automatically selected from a total number of fracturing stages (S) per well (w) input in step 202 or, alternatively, may be selected using the client interface and/or the video interface described further in reference to FIG. 6.

In step 303, a fracture plane (f) is automatically selected from a total number of fracture planes (F) per fracturing stage (s) input in step 202 or, alternatively, may be selected using the client interface and/or the video interface described further in reference to FIG. 6. It is assumed that the fracture planes (f) within each fracturing stage (s) are distributed as clusters and not the simplified single bi-wing fractures.

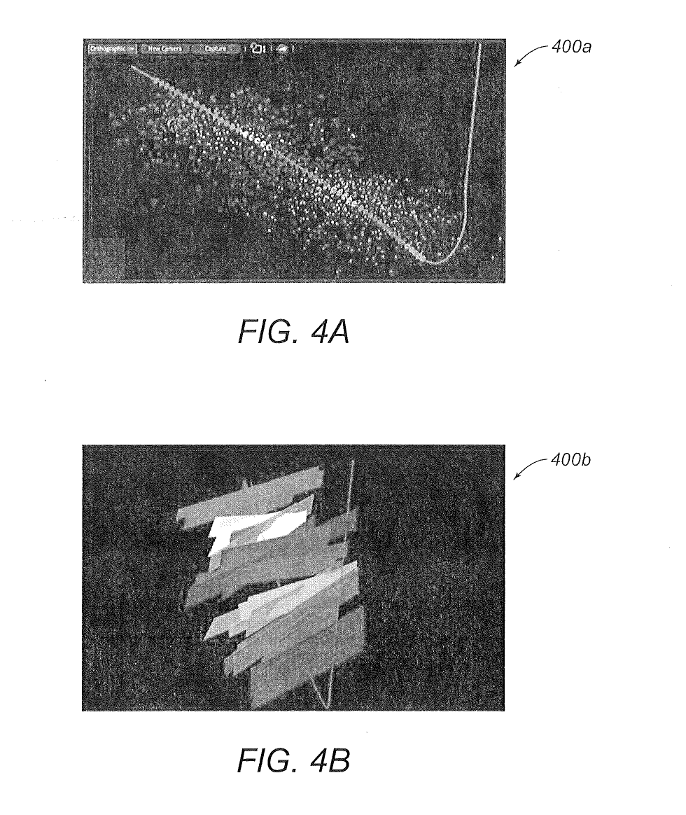

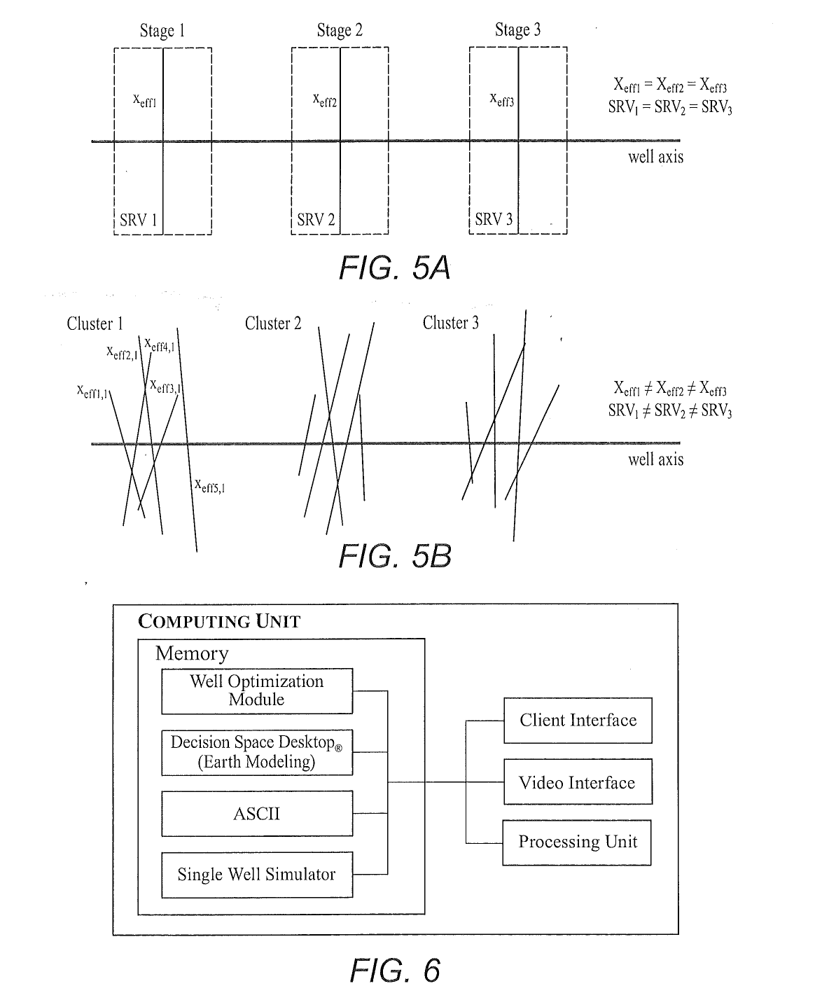

In step 304, the effective fracture length (x_{eff,s,f}^{w}) for the selected fracture plane (f), fracturing stage (s) and well (w) is read from the data corresponding to the CFN model input in step 202. The data corresponding to the CFN model may include, for example, the number of 3D fracture planes for a cluster per fracturing stage. The 3D fracture planes are constructed based on a temporal analysis of micro-seismic imaging events. In FIG. 4A, a display 400a of a collection of interpreted micro-seismic imaging events associated with a fracture cluster is illustrated. In FIG. 4B, a display 400b of 3D fracture planes based on a time correlation of the micro-seismic imaging events in FIG. 4A is illustrated. The 3D fracture planes in the display 400b are protruded by a well trajectory to illustrate the interpreted results of the fracking process. Based on this data input from step 202, the dimension or length of the longest axis of the selected fracture plane (f), for fracturing stage (s) and well (w) may be read and designated as the effective fracture length of that selected fracture plane (f). In FIG. 5B, a complex schematic model of an induced fracture system illustrates multiple-complex fracture networks, each with different (x_{eff}), different (SRV) and multiple fractures per fracturing stage. As compared to the simplified model of an induced fracture system based on bi-wing fractures illustrated in FIG. 5A, the advantages of the more complex model in FIG. 5B are readily apparent in view of the much more accurate representation of the fracture system.

In step 305, the average effective fracture length (\hat{x}_{eff,s,f}^{w}) for fracturing stage (s) is calculated using each effective fracture length read in step 304 and equation

$${\hat{x}}_{eff , s}^{w} = \frac{1}{F} {\sum }_{f = 1}^{F} {x}_{eff , s , f}^{w} \qquad ( 2 )$$

wherein (\hat{x}_{eff,s,f}^{w}) corresponds to the effective fracture length for selected fracture plane (f) within a selected fracturing stage (s).

In step 306, the method 300 determines if there is another fracture plane (f) to select from the total number of fracture planes (F). If there is another fracture plane (f) to select, then the method 300 returns to step 303 to select another fracture plane (f) from the total number of fracture planes (F). If there is not another fracture planex (f) to select, then the method 300 proceeds to step 307.

In step 307, the method 300 determines if there is another fracturing stage (s) to select from the total number of fracturing stages (S). If there is another fracturing stage (s) to select, then the method 300 returns to step 302 to select another fracturing stage (s) from the total number of fracturing stages (S). If there is not another fracturing stage (s) to select, then the method 300 proceeds to step 308.

In step 308, the method 300 determines if there is another well (w) to select from the total number of wells (W). If there is another well (w) to select, then the method 300 returns to step 301 to select another well (w) from the total number of wells (W). If there is not another well (w) to select, then the method 300 proceeds to step 309.

In step 309, a reservoir or a well-log property (p) is automatically selected from a total number of Complex reservoir properties (P) input in step 202, or, alternatively, may be selected using the client interface and/or the video interface described further in reference to FIG. 6.

In step 310, the average effective fracture length (\hat{x}_{eff,s,f}^{w}) for each respective fracturing stage (s) calculated in step 305 is correlated with the reservoir or well-log property (p) selected in step 309 to build a distribution (discrete or continuous) of the average effective fracture lengths (\tilde{x}_{eff,s|p}^{w}). A discrete conditional distribution (histogram) may be built using equation 3:

$${\tilde{x}}_{eff , s \vert p}^{w} = Prob ( {X}_{eff} = {\hat{x}}_{eff , s}^{w} \vert P = p ) = \frac{Prob ( P = p ⋂ {X}_{eff} = {\hat{x}}_{eff , s}^{w} )}{Prob ( P = p )} \qquad ( 3 )$$

wherein “Prob” denotes “probability”, (x_{eff}) defines the overall sampling domain of the average effective fracture length as the dependent probabilistic variable, and (P) defines the overall sampling domain of the complex reservoir property as the independent probabilistic variable.

Alternatively, a continuous conditional distribution (pdf) may be built using equation 4:

$${\tilde{x}}_{eff , s \vert p}^{w} = Prob ( {X}_{eff} = {\hat{x}}_{eff , s}^{w} \vert P = p ) = \frac{{Prob}_{P , {X}_{eff}} ( p , {\hat{x}}_{eff , s}^{w} )}{{Prob}_{P} ( p )} \qquad ( 4 )$$

wherein (Prob_{P,X}_{_{eff}}(p, \hat{x}_{eff,s}^{w})) defines the joint density (pdf) of (P) and (x_{eff}), while (Prob_{P}(p)) defines the marginal density for (P). For pdf normalization purposes it is necessary to hold Prob_{P}(p)>0.

In step 312, the method 300 determines if there is another reservoir or well-log property (p) to select from the total number of complex reservoir properties (P). If there is another reservoir or well-log property (p) to select, then the method 300 returns to step 309 to select another reservoir or well-log property (p) from the total number of complex reservoir properties (P). If there is not another reservoir or well-log property (p) to select, then the method 300 returns the distribution of average effective fracture lengths to step 204.

### System Description

The present invention may be implemented through a computer executable program of instructions, such as program modules, generally referred to as software applications or application programs executed by a computer. The software may include, for example, routines, programs, objects, components and data structures that perform particular tasks or implement particular abstract data types. The software forms an interface to allow a computer to react according to a source of input. DecisionSpace® Desktop (Earth Modeling), which is a commercial software application marketed by Landmark Graphics Corporation, may be used as interface applications to implement the present invention. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g. various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

Referring now to FIG. 6, a block diagram illustrates one embodiment of a system for implementing the present invention on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the invention.

The memory primarily stores the application programs, which may also be described as program modules containing computer executable instructions, executed by the computing unit for implementing the present invention described herein and illustrated in FIGS. 2-3. The memory therefore, includes a well optimization module, which enables the methods described in reference to steps 204-205 in FIG. 2. The memory also includes a single well simulator, which enables the performance of step 206 in FIG. 2. Quick Look™ and Knoesis/Slate^{SM} are examples of single-well simulators marketed by Halliburton Company that may be used. The foregoing modules and applications may integrate functionality from the remaining application programs illustrated in FIG. 6. In particular, DecisionSpace® Desktop (Earth Modeling) may be used as an interface application to perform steps 202 and 208 in FIG. 2. ASCII files are also included in the memory for storing the data input from step 202 in FIG. 2. Although DecisionSpace® Desktop (Earth Modeling) and a single well simulator may be used as interface applications, other interface applications may be used, instead, or the well optimization module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well-known.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A method for optimizing well production in a simulated reservoir volume, which comprises:
inputting one or more complex reservoir properties and one or more complex fracture network properties, the complex fracture network properties comprising data corresponding to clusters in a complex fracture network model;
determining a distribution of average effective fracture lengths based on the complex reservoir properties and the complex fracture network properties;
sampling an average effective fracture length from the distribution of average effective fracture lengths using a computer processor; and
optimizing well production by history matching using the distribution of average effective fracture lengths and the sampled average effective fracture length to improve permeability of the simulated reservoir volume.

2. The method of claim 1, wherein the history matching is performed by a single well reservoir simulator.

3. The method of claim 1, wherein the distribution of average effective fracture lengths is determined by:
reading an effective fracture length for each fracture plane in each fracturing stage for each well;
calculating the average effective fracture length for each fracturing stage using each effective fracture length for a respective fracturing stage; and
building the distribution of average effective fracture lengths by correlating the average effective fracture length for each respective fracturing stage with each reservoir or well-log property.

4. The method of claim 3, wherein the distribution of average effective fracture lengths is a discrete conditional distribution that is built by:
$${\tilde{x}}_{eff , s \vert p}^{w} = Prob ( {X}_{eff} = {\hat{x}}_{eff , s}^{w} \vert P = p ) = \frac{Prob ( P = p ⋂ {X}_{eff} = {\hat{x}}_{eff , s}^{w} )}{Prob ( P = p )} .$$
or a continuous conditional distribution that is built by:
$${\tilde{x}}_{eff , s \vert p}^{w} = Prob ( {X}_{eff} = {\hat{x}}_{eff , s}^{w} \vert P = p ) = \frac{{Prob}_{P , {X}_{eff}} ( p , {\hat{x}}_{eff , s}^{w} )}{{Prob}_{P} ( p )} .$$

5. The method of claim 3, wherein a longest axis of each fracture plane is read and designated as the effective fracture length for each respective fracture plane.

6. The method of claim 3, wherein the average effective fracture length for each fracturing stage is calculated by:
$${\hat{x}}_{eff , s}^{w} = \frac{1}{F} {\sum }_{f = 1}^{F} {x}_{eff , s , f}^{w} .$$

7. The method of claim 3, wherein each reservoir or well-log property is a complex reservoir property.

8. The method of claim 3, wherein each fracturing stage for each well comprises a plurality of fracture planes, each fracture plane within a respective fracturing stage having a different effective fracture length.

9. A non-transitory program carrier device tangibly carrying computer executable instructions for optimizing well production in a simulated reservoir volume, the instructions being executable to implement:
inputting one or more complex reservoir properties and one or more complex fracture network properties, the complex fracture network properties comprising data corresponding to clusters in a complex fracture network model;
determining a distribution of average effective fracture lengths based on the complex reservoir properties and the complex fracture network properties;
sampling an average effective fracture length from the distribution of average effective fracture lengths; and
optimizing well production by history matching using the distribution of average effective fracture lengths and the sampled average effective fracture length to improve permeability of the simulated reservoir volume.

10. The program carrier device of claim 9, wherein the history matching is performed by a single well reservoir simulator.

11. The program carrier device of claim 9, wherein the distribution of average effective fracture lengths is determined by:
reading an effective fracture length for each fracture plane in each fracturing stage for each well;
calculating the average effective fracture length for each fracturing stage using each effective fracture length for a respective fracturing stage; and
building the distribution of average effective fracture lengths by correlating the average effective fracture length for each respective fracturing stage with each reservoir or well-log property.

12. The program carrier device of claim 11, wherein the distribution of average effective fracture lengths is a discrete conditional distribution that is built by:
$${\tilde{x}}_{eff , s \vert p}^{w} = Prob ( {X}_{eff} = {\hat{x}}_{eff , s}^{w} \vert P = p ) = \frac{Prob ( P = p ⋂ {X}_{eff} = {\hat{x}}_{eff , s}^{w} )}{Prob ( P = p )} .$$
or a continuous conditional distribution that is built by:
$${\tilde{x}}_{eff , s \vert p}^{w} = Prob ( {X}_{eff} = {\hat{x}}_{eff , s}^{w} \vert P = p ) = \frac{{Prob}_{P , {X}_{eff}} ( p , {\hat{x}}_{eff , s}^{w} )}{{Prob}_{P} ( p )} .$$

13. The program carrier device of claim 11, wherein a longest axis of each fracture plane is read and designated as the effective fracture length for each respective fracture plane.

14. The program carrier device of claim 11, wherein the average effective fracture length for each fracturing stage is calculated by:
$${\hat{x}}_{eff , s}^{w} = \frac{1}{F} {\sum }_{f = 1}^{F} {x}_{eff , s , f}^{w} .$$

15. The program carrier device of claim 11, wherein each reservoir or well-log property is a complex reservoir property.

16. The program carrier device of claim 11, wherein each fracturing stage for each well comprises a plurality of fracture planes, each fracture plane within a respective fracturing stage having a different effective fracture length.

17. A method for optimizing well production in a simulated reservoir volume, which comprises:
inputting one or more complex reservoir properties and one or more complex fracture network properties, the complex fracture network properties comprising data corresponding to clusters in a complex fracture network model;
determining a distribution of average effective fracture lengths by:
reading an effective fracture length for each fracture plane in each fracturing stage for each well;
calculating an average effective fracture length for each fracturing stage using each effective fracture length for a respective fracturing stage; and
building the distribution of average effective fracture lengths by correlating the average effective fracture length for each respective fracturing stage with each reservoir or well-log property;
sampling the average effective fracture length from the distribution of average effective fracture lengths; and
optimizing well production by history matching using the distribution of average effective fracture lengths and the sampled average effective fracture length to improve permeability of the simulated reservoir volume.

18. The method of claim 17, wherein the distribution of average effective fracture lengths is a discrete conditional distribution that is built by:
$${\tilde{x}}_{eff , s \vert p}^{w} = Prob ( {X}_{eff} = {\hat{x}}_{eff , s}^{w} \vert P = p ) = \frac{Prob ( P = p ⋂ {X}_{eff} = {\hat{x}}_{eff , s}^{w} )}{Prob ( P = p )} .$$
or a continuous conditional distribution that is built by:
$${\tilde{x}}_{eff , s \vert p}^{w} = Prob ( {X}_{eff} = {\hat{x}}_{eff , s}^{w} \vert P = p ) = \frac{{Prob}_{P , {X}_{eff}} ( p , {\hat{x}}_{eff , s}^{w} )}{{Prob}_{P} ( p )} .$$

19. The method of claim 17, wherein a longest axis of each fracture plane is read and designated as the effective fracture length for each respective fracture plane.

20. The method of claim 17, wherein the average effective fracture length for each fracturing stage is calculated by:
$${\hat{x}}_{eff , s}^{w} = \frac{1}{F} {\sum }_{f = 1}^{F} {x}_{eff , s , f}^{w} .$$
